(19) United States
(12) Patent Application Publication
(10) Pub. No.: US 2020/0357059 A1
(43) Pub. Date: Nov. 12, 2020

(54) Multi-layer machine learning validation of income values

(71) Applicant: PointPredictive Inc., San Diego, CA (US)

(72) Inventors: Michael J. Kennedy, Encinitas, CA (US); Gregory Gancarz, San Diego, CA (US); Shi Shu, San Diego, CA (US)

(73) Assignee: PointPredictive Inc., San Diego, CA (US)

(21) Appl. No.: 16/501,613

(22) Filed: May 7, 2019

(51) Int. Cl. G06Q 40/02; G06N 7/00; G06N 20/20; G06F 21/62

(52) U.S. Cl. CPC G06Q 40/025; G06F 21/6245; G06N 20/20; G06N 7/00

(57) ABSTRACT

The present disclosure relates generally to a calculated probability that an income value has been misrepresented in a risk analysis system. For example, the system may apply first data to a first machine learning (ML) model to determine a conservative income prediction associated with the data and apply second data to a second ML model to determine a probability that an overstatement of the income value would result in a change in an approval determination.

### BACKGROUND

The present application is generally related to improving electronic data accuracy and reducing risk of electronic transmissions between multiple sources using multiple communication networks. In particular, data inaccuracy and risk associated with inaccurate data can be prevalent in any context or industry, especially when the data are relied on to generate a determination for approval of accessing an item or service.

Customary authorization techniques approving access to the item or service may rely on such data without many means to confirm it. Additionally, the means of confirmation may be costly (e.g., in electronic or labor resources, time, money, etc.). Entities that may rely on the data may want to know when such added costs are necessary as well as when they are not. As such, improved authorization techniques of electronic data are required.

### BRIEF SUMMARY

One aspect of the present disclosure relates to systems and methods for estimating a probability of changing a determination for approval due to an overstatement of an income value. The method may comprise, for example, determining, by a computer system, a conservative income prediction associated with the application data by applying a set of inputs to a first trained machine-learning (ML) model, wherein the set of inputs includes at least some of the application data; receiving, by the computer system, application data by a user requesting access to an item or service, wherein the application data includes the income value; determining an inflation score by comparing the income value with the conservative income prediction, wherein the inflation score is associated with an amount the income value is different than the conservative income prediction; determining, by the computer system, a first decision likelihood score by applying the income value and the set of inputs to a second trained ML model; determining, by the computer system, a second decision likelihood score by applying the conservative income prediction and the set of inputs to the second trained ML model; estimating the probability of changing the determination for approval due to the overstatement of the income value by comparing the first decision likelihood score with the second decision likelihood score; and providing, by the computer system, the a score representing the probability of changing the determination for approval to a user device.

### BRIEF DESCRIPTION OF THE DRAWINGS

Illustrative embodiments of the present disclosure are described in detail below with reference to the following figures.

FIG. 1 illustrates a distributed system for risk analysis according to an embodiment of the disclosure.

FIG. 2 illustrates a distributed system for risk analysis according to an embodiment of the disclosure.

FIG. 3 illustrates a distributed system for training one or more ML models according to an embodiment of the disclosure.

FIG. 4 illustrates a risk analysis process implemented by a distributed system according to an embodiment of the disclosure.

FIG. 5 illustrates a sample output according to an embodiment of the disclosure.

FIG. 6 illustrates a first notification according to an embodiment of the disclosure.

FIG. 7 illustrates a second notification according to an embodiment of the disclosure.

FIG. 8 illustrates an example of a computer system that may be used to implement certain embodiments of the disclosure.

### DETAILED DESCRIPTION

In the following description, various embodiments will be described. It should be apparent to one skilled in the art that embodiments may be practiced without specific details, which may have been admitted or simplified in order to not obscure the embodiment described.

Embodiments of the present disclosure are directed to, among other things, a risk analysis system that determines a calculated probability that an income value has been misrepresented (e.g., using one or more ML models that estimate the probability that income is overstated by some minimum amount, for example, fifteen-percent). For example, the computer system may apply first data to a first machine learning (ML) model to determine a conservative income prediction and/or inflation score associated with an income value. The computer system may also apply second data to a second ML model to estimate a probability that an overstatement of the income value would result in a change in the approval determination. The methods and systems described herein may correspond with any determination where a user has asserted their income value, and where that income value can make a difference in a decision by a second user. This may include loan or non-loan cases including, for example, membership to a private venue or country club, a loan to borrow funds, or providing proof that a person's income value qualifies them for a program, like a government subsidy.

The computer system may implement multiple machine learning (ML) models. For example, a first ML model may determine one or more income predictions for one or more user segments (e.g., grouped by demographic data, employment data, geographic data, etc.), which predictions may include a conservative estimate of income. The computer system may also receive application data from a user corresponding with a particular segment from these one or more user segments. The computer system may determine an inflation score by comparing the income value received from the application data with the income prediction related to the first ML model. The computer system may also apply the income value received from the application data to the second ML model. Output from the second. ML model may to determine a first decision likelihood score corresponding with the chance of being approved in association with the stating the particular income value. The second ML model may also apply the income prediction and a set of inputs to determine a second decision likelihood score corresponding with the chance of being approved, had the user stated the conservative income prediction value. The outputs from the second ML model may be compared (e.g., the stated income value and the conservative prediction income value) and a determination of a score corresponding to an estimate of the probability of changing the determination for approval due to overstatement of the income value may be determined and provided to a user device.

As a sample illustration, the computer system may determine a conservative income prediction for a new manager in Anytown USA as $85,000, corresponding with the output from a first trained ML model. The computer system may also receive an application to access a country club (e.g., an item or service) from a user. According to the application, the user works as a manager in Anytown USA. The application to access the country club may also state that the user's income is $300,000. The computer system may determine an inflation score of the income value by comparing $300,000 with $85,000 (e.g., a potential inflation of $215,000). The computer system may also determine a probability that an overstatement of the income value would result in a change in the approval determination associated with the user's application data. The computer system may determine a plurality of decision likelihood scores. The first decision likelihood score may correspond with the stated income from the application data and input values to the second ML model, which for example, may result in a 60-percent chance of being approved. The second decision likelihood score may also be determined, associated with the conservative income prediction and the input values to the second ML model, which for example, may result in a 40-percent chance of being approved. The calculated probability of changing the determination for approval due to the apparent overstatement of the income value may be approximated, in this example, by subtracting 60−40, or 20-percent chance of changing the determination for approval.

Various technical improvements to conventional systems are identified by the disclosure. For example, conventional systems may only target unusually high incomes, even though moderate-seeming incomes may still be overstated and potentially represent high risk. Hence, the use of a conservative income estimate in the present disclosure, along with a risk estimate, may capture more instances of risk. Another potential failure with conventional systems is that users may attempt to verify income values based on the overall assessed risk of the application, possibly including credit risk or payment capacity at stated income value, which leads to sub-optimal decisions. For example, application data may identify a high credit risk and low income value, but be very unlikely to be overstating their income, versus application data corresponding with low credit risk, moderate stated income, and low-risk overall with a higher risk for income overstatement. This improved system can isolate the risk of income overstatement from other risk elements, thereby leading to more appropriately targeted remediating actions. It may also differentiate between likely overstatements that may not affect the approval decision likelihood with the income overstatements that affect the approval decision likelihood, which can also correlate with default risk.

The improved computing system described herein may increase efficiency of application processing and reduce risk of erroneous application approval for conventional systems. For example, the computing system described herein can compare conservative income predictions with stated income values to help determine whether users should receive additional information or third-party verification, or if the users may trust the stated income. The improved computer system is able to limit the amount of data received when confirming whether the determination of approval of the application would have been changed, which can increase efficiency, minimize data retention of the overall system, and result in fewer electronic communications over communication networks. As such, the present disclosure creates a unique computing system with modules and engines that improve on conventional systems.

Other technical improvements may be realized as well. For example, the improved computer system may identify riskier application data and filter or remove requirements to receive additional application data for applications that are less risky when compared to a threshold. By filtering lower risk application data, including lower risk income values, the overall computational efficiency of the system may be increased. The improved computer system may also increase throughput of application data by reducing time-consuming data analysis from third parties. The computer system may limit or eliminate the need to request additional data for application data that has not been identified as risky according to the machine learning models.

The system may also improve customer service by requiring fewer additional data submissions from an applicant. This may result in increased application completion rates, increased offer acceptance, and/or a potential ability to beneficially adjust overall pricing.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and examples, will be described in more detail below in the following specification, claims, and accompanying drawings.

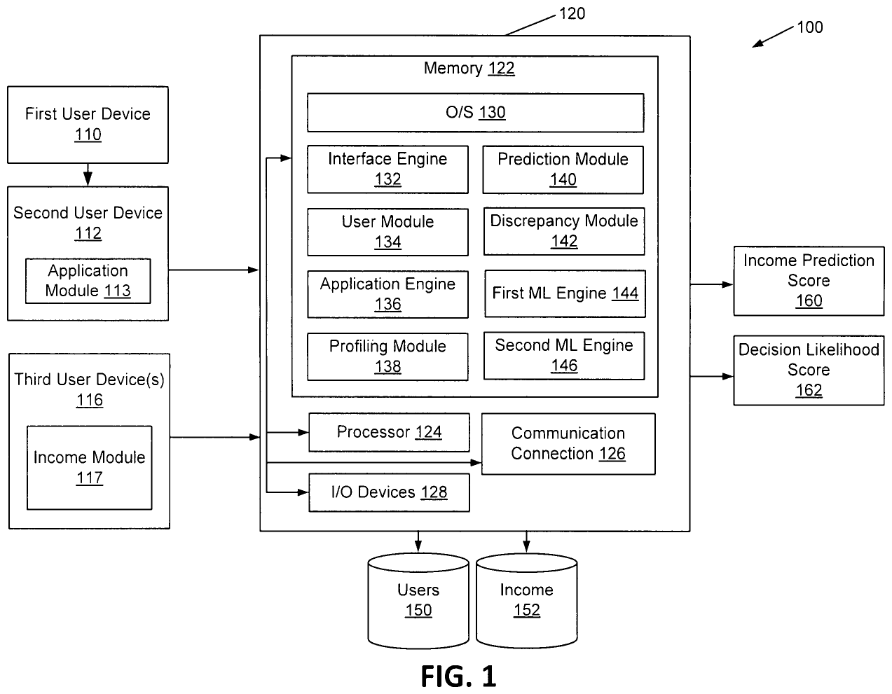

FIG. 1 illustrates a distributed system for risk analysis according to an embodiment of the disclosure. In example 100, a distributed system is illustrated, including a first user device 110, a second user device 112, a third user device 116, and a risk assessment computer system 120. In some examples, devices illustrated herein may comprise a mixture of physical and cloud computing components. Each of these devices may transmit electronic messages via a communication network. Names of these and other computing devices are provided for illustrative purposes and should not limit implementations of the disclosure.

The first user device 110, second user device 112, and third user device 116 may display content received from one or more other computer systems, and may support various types of user interactions with the content. These devices may include mobile or non-mobile devices such as smartphones, tablet computers, personal digital assistants, and wearable computing devices. Such devices may run a variety of operating systems and may be enabled for Internet, e-mail, short message service (SMS), Bluetooth®, mobile radio-frequency identification (M-RFID), and/or other communication protocols. These devices may be general purpose personal computers or special-purpose computing devices including, by way of example, personal computers, laptop computers, workstation computers, projection devices, and interactive room display systems. Additionally, first user device 110, second user device 112, and third user device 116 may be any other electronic devices, such as a thin-client computers, Internet-enabled gaming systems, business or home appliances, and/or personal messaging devices, capable of communicating over network(s).

In different contexts, first user device 110, second user device 112, and third user device 116 may correspond to different types of specialized devices. In some embodiments, one or more of these devices may operate in the same physical location, such as a finance center or other location that manages or restricts access to items or services. In such cases, the devices may contain components that support direct communications with other nearby devices, such as wireless transceivers and wireless communication interfaces, Ethernet sockets or other Local Area Network (LAN) interfaces, etc. In other implementations, these devices need not be used at the same location, but may be used in remote geographic locations in which each device may use security features and/or specialized hardware (e.g., hardware-accelerated SSL and HTTPS, WS-Security, firewalls, etc.) to communicate with the risk assessment computer system 120 and/or other remotely located user devices.

The first user device 110, second user device 112, and third user device 116 may comprise one or more applications that may allow these devices to interact with other computers or devices on a network, including cloud-based software services. The application may be capable of handling requests from many users and posting various webpages. In some examples, the application may help receive and transmit application data or other information to various devices on the network.

The first user device 110, second user device 112, and third user device 116 may include at least one memory and one or more processing units that may be implemented as hardware, computer executable instructions, firmware, or combinations thereof. The computer executable instruction or firmware implementations of the processor may include computer executable machine executable instructions written in any suitable programming language to perform the various functions described herein. These user devices may also include geolocation devices communicating with a global positioning system (GPS) device for providing or recording geographic location information associated with the user devices.

The memory may store program instructions that are loadable and executable on processors of the user devices, as well as data generated during execution of these programs. Depending on the configuration and type of user device, the memory may be volatile (e.g., random access memory (RAM), etc.) and/or non-volatile (e.g., read-only memory (ROM), flash memory, etc.). The user devices may also include additional removable storage and/or non-removable storage including, but not limited to, magnetic storage, optical disks, and/or tape storage. The disk drives and their associated computer-readable media may provide non-volatile storage of computer-readable instructions, data structures, program modules, and other data for the computing devices. In some implementations, the memory may include multiple different types of memory, such as static random access memory (SRAM), dynamic random access memory (DRAM), or ROM.

The first user device 110, second user device 112, third user device 116, and the risk assessment computer system 120 may communicate via one or more networks, including private or public networks. Some examples of networks may include cable networks, the Internet, wireless networks, cellular networks, and the like.

As illustrated in FIG. 1, the first user device 110 may correspond with a first user. The first user may provide application data associated with geographic, demographic, and/or employment data to support a determination for approval for access to an item or service (e.g., a reservation, ordering an item, initiating a loan, lease, or purchase of the item or service, etc.).

In some examples, the application data may contain income value, employment history, or other information that may enable validation of a claimed income. The information may include employment, location, or income value associated with the user, yet without an identification of the user itself. In some examples, the application data may be limited to a predetermined number of fields (e.g., a predetermined selection of 10-15 fields, etc.) including fields data that are associated with one or more user segments.

The application data may also correspond with characteristics of the first user device 110. For example, the application data may include a user device identifier, as described herein, or an identification of a communication network utilized by the user device to communicate with other devices.

The second user device 112 may correspond with a second user that restricts access to an item or service. The second user device 112 may be configured to receive and transmit application data to various computing devices.

The second user device 112 may execute an application module 113. The second user device 112 may receive the application data through the application module 113, which may be configured to access application data. For example, the first user may provide application data to application module 113. In such examples, the application may be submitted for the first user by the second user device 112 to the risk assessment computer system 120 for processing.

The application module 113 may be configured to receive or generate the application data. The application data may be transmitted via a network from a first user device 110 or, in some examples, may be provided directly at the second user device 112 via a user interface and without a network transmission. The application module 113 may provide a template to receive application data corresponding with a variety of characteristics associated with the first user.

The application module 113 can receive domain-specific data as well, including data that may be optional for some applications and missing or not included with other applications. The optional data may comprise payment to income (PTI) ratios or debt to income (DTI) ratios. The optional data may be included with other application data in an electronic transmission to the risk assessment computer system 120. When the optional data is received with the other application data, the optional data may be provided as input values to one or more ML models and weighted according to the training data provided previously.

In some examples, application module 113 may receive application data that does not include personally identifiable information (PII) of the user. PII may include a name, birthday, home address, or other unique identifier (e.g., Social Security Number; etc.) associated with the user. The computer system may limit the application data to information other than PII data. In some examples, this may improve security and privacy of the user to determine risk assessment, as well as increase the efficiency and processing of receiving output from the first and second ML models (e.g., the conservative income prediction, the first decision likelihood score, the second decision likelihood score, etc.).

The application data may correspond with one or more user segments. For example, the one or more user segments may group users according to characteristics correlating with the application data. In a sample illustration, a first user segment may correspond with users whose occupation is listed as a manager in the application data, a second user segment whose occupation location includes Anytown USA, and a third user segment that includes a combination of the first and second user segments (e.g., a combined segment of managers from Anytown USA).

The application module 113 may be configured to transmit application data to the risk assessment computer system 120. The application data may be encoded in electronic message and transmitted via a network to an application programming interface (API) associated with the risk assessment computer system 120.

As illustrated in FIG. 1, the third user device 116 may correspond with a third user that can manage the receipt, generation, and/or transmission of income values for a plurality of user segments. The third user device 116 may execute an income module 117. The data transmitted by the third user device 116 may be received by the risk assessment computer system 120 and stored with the profile data store 150 and income data store 152. In some examples, the income module 117 may provide statistical summaries of income data across different user segments, including statistical summaries associated with location, employer, and occupation; and at different levels of aggregation such as ZIP code, city, and state.

The first user device 110, second user device 112, or third user device 116 may transmit electronic communications with a risk assessment computer system 120. The risk assessment computer system 120 may correspond with any computing devices or servers on a distributed network, including processing units 124 that communicate with a number of peripheral subsystems via a bus subsystem. These peripheral subsystems may include memory 122, a communications connection 126, and/or input/output devices 128.

The memory 122 of the risk assessment computer system 120 may start program instructions that are loadable and executable on processor 124, as well as data generated during the execution of these programs. Depending on the configuration and type of risk assessment computer system 120, the memory may be volatile (such as random access memory (RAM)) and/or non-volatile (such as read-only memory (ROM), flash memory, etc.). The risk assessment computer system 120 may also include additional removable storage and/or non-removable storage including, but not limited to, magnetic storage, optical disks, and/or tape storage. The disk drives and their associated computer-readable media may provide non-volatile storage of computer-readable instructions, data structures, program modules, and other data for the risk assessment computer system 120. In some implementations, the memory may include multiple different types of memory, such as solid state drives (SSD), SRAM, DRAM, or ROM.

The memory 122 is an example of computer readable storage media. For example, computer storage media may include volatile or nonvolatile, removable or non-removable media, implemented in any methodology or technology for storage of information such that computer readable instructions, data structures, program modules, or other data. Additional types of memory computer storage media may include PRAM, SRAM, DRAM, RAM, ROM, EEPROM, flash memory or other memory technology, CD-ROM, DVD or other optical storage, magnetic cassettes, magnetic tape, magnetic disk storage or other magnetic storage devices, or any other medium which can be used to store the desired information and which can be accessed by the risk assessment computer system 120. Combinations of any of the above should also be included within the scope of computer-readable media.

The communications connection 126 may allow the risk assessment computer system 120 to communicate with a data store, one or more databases, server, or other device on the network. The risk assessment computer system 120 may also include input/output devices 128, such as a keyboard, a mouse, a voice input device, a display, speakers, a printer, and the like.

Reviewing the contents of memory 122 in more detail, the memory 122 may comprise an operating system 130, an interface engine 132, a user module 134, an application engine 136, a profiling module 138, a prediction module 140, a discrepancy module 142, a first ML engine 144, and/or a second engine 146. The risk assessment computer system 120 may receive and store data in various data stores, including a profile data store 150 and income data store 152. The modules and engines described herein may be software modules, hardware modules, or a combination thereof. If the modules are software modules, the modules will be embodied in a non-transitory computer readable medium and processed by a processor with computer systems described herein.

The risk assessment computer system 120 may comprise an interface engine 132. The interface engine 132 may be configured to receive application data and/or transmit output to user devices (e.g., predictions or scores, etc.). In some examples, the interface engine 132 may implement an application programming interface (API) to receive or transmit data.

The risk assessment computer system 120 may also comprise a user module 134. The user module 134 may be configured to identify one or more users or user devices associated with the risk assessment computer system 120. Each of the users or user devices may be associated with a user identifier and a plurality of data stored with the profile data store 150.

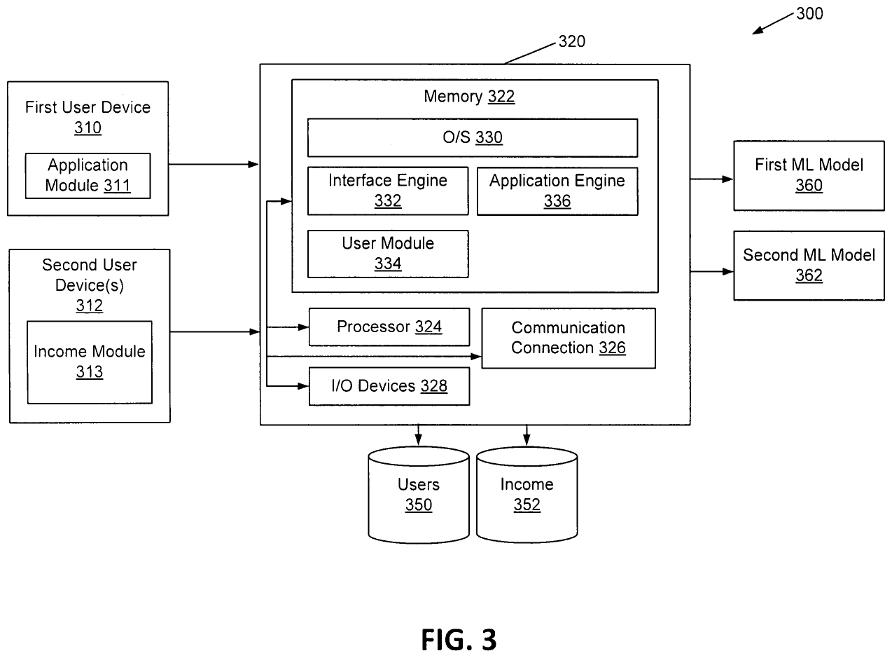

The user module 134 may be configured to identify information for a group of users. Data may be received as corresponding with individual users and grouped during pre-processing or model training, as illustrated with FIG. 3. The group of users may be grouped by a common description, including a common occupation, a common city, or a common state, etc. New data received during production processing may correlate the new user with previously identified groups of users determined. during the training phase.

The risk assessment computer system 120 may comprise an application engine 136. The application engine 136 may be configured to receive application data associated with an application object. The application data may be received from one or more user devices (e.g., second user device 112, or a third user device 116, etc.) via a network communication message, API transmission, or other methods described herein.

The application data may comprise various string, integer, and float values. An illustrative plurality of input fields may comprise an interface version number, account identifier of a first user, account identifier of the second user, application identifier, applicant street address, applicant city, applicant state, applicant ZIP Code, annual stated income value, date of birth, occupation, employer name, employer phone number, employer city, employer ZIP Code, calculated debt to income percentage (DTI), and/or calculated payment to income percentage (PTI). The application data may also comprise monthly update fields which may include the application identifier and a verified annual income.

In some examples, the application engine 136 may provide additional information when an inflation score is outside of an acceptable threshold range. For example, the application engine 136 may correlate the inflation score with a plurality of inflation scores on an acceptable threshold range of scores. When the inflation score corresponds with an income value being outside of the acceptable threshold range, the application engine 136 may identify one or more reason codes with the inflation score along the threshold range. For example, the reason codes may correspond with a textual description of one or more potential reasons for receiving a particular inflation score or decision likelihood score.

The application engine 136 may also be configured to filter or limit the application data received from the first user device 110, second user device 112, or third user device 116.

The risk assessment computer system 120 may also comprise a profiling module 138. The profiling module 138 may be configured to determine and manage a profile of a first user. The profile may correspond with one or more characteristics of the user, including income value, employment, identity, or the like. The profiling module 138 may store data corresponding with the users in the profile data store 150.

The profiling module 138 may also be configured to determine one or more user segments. The profiling module 138 may receive income values from different user segments associated with the income module 117 and aggregate the data by user segment. In some examples, the income value for each user segment may be combined or aggregated for the user segment and used as a scoring feature for one or more machine learning models. The data may be stored with the income data store 152.

The risk assessment computer system 120 may also comprise a prediction module 140. The prediction module 140 may be configured to determine a plurality of income predictions, including a conservative income prediction, each of which may be associated with the set of user segments identified by the user device(s) or the profiling module 138. For example, the prediction module 140 may determine a conservative income prediction associated with the application data by applying a set of inputs to a first trained ML model. The set of inputs may comprise information associated with the application data or data received from the third user device 116.

The prediction module 140 may calculate a conservative income prediction or inflation score, at least in part, using a quantile regression method or quantile random forest method. For example, the quantile regression calculation may estimate a conditional median or other quantiles of the predicted income value associated with each user segment.

The prediction module 140 may also be configured to determine a best guess of the first user's income value or a range of incomes that include a low income value and high income value along the predicted income range. In some examples, an electronic notification may be transmitted to a user device. The notification may comprise recommendations to the second user, who may use those recommendations, scores, and/or their own segmentations and strategies to make the decision to request (or not request) further information/validation of income. In some examples, the notification may be transmitted prior to receiving additional information with the application. In some examples, when the received income is within the income range, additional information may not be necessary and may limit a somewhat lengthy process of receiving and processing additional application data. The additional application data may include requesting pay stubs, contacting the user via a verification call, or paying for an extensive search of personal data by a third-party service.

The risk assessment computer system 120 may also comprise a discrepancy module 142. The discrepancy module 142 may be configured to determine an inflation score by comparing the income value with the conservative income prediction, at least in part to identify any discrepancies between the two values. In some examples, the inflation score is associated with an amount the income value is different than the conservative income prediction.

In some examples, the discrepancy module 142 may be configured to determine differences and discrepancies between information provided with the application as application data and threshold values associated with a user segment (e.g., from a third user device 116, third party data sources, etc.). For example, a first user segment may correspond with a combination of a particular career in a particular location with a particular salary range. When the application data asserts a different salary that falls outside of the salary range, the discrepancy module 142 may be configured to identify that discrepancy between the provided data and the expected data associated with the first segment user profile. In some examples, each discrepancy may adjust the application score for an increased likelihood of risk through overstatement of the income value (e.g., increase the score to a greater score than an application without the discrepancy, etc.).

The discrepancy module 142 may also be configured to determine a score corresponding to an estimate of the probability of changing the determination for approval due to the overstatements of the income value. For example, the discrepancy module 142 may determine a first decision likelihood score that corresponds with the stated income from the application data and input values to the second ML model. The stated income may be applied to the second ML model to determine the first decision likelihood score. The discrepancy module 142 may also determine a second decision likelihood score that corresponds with the conservative income prediction from the application data and input values to the second ML model. The conservative income prediction may be applied to the second ML model to determine the second decision likelihood score. Using these scores, the discrepancy module 142 may determine a likelihood of changing an approval based at least in part on the difference in the income values.

In some examples, the discrepancy module 142 may base the determination on comparing the first decision likelihood score with the second decision likelihood score. In some examples, the comparison of the first decision likelihood score with the second decision likelihood score may include subtracting the second score from the first score. As a sample illustration, the first decision likelihood score may be calculated as a 60-percent chance of being approved and the second decision likelihood score may be calculated as a 40-percent chance of being approved. The calculated probability of changing the determination for approval due to the apparent overstatement of the income value may be determined, in this example, by subtracting 60−40, or 20-percent chance of changing the determination for approval.

The discrepancy module 142 may also be configured to determine whether the income value is within a threshold value of an expected value, where the expected value is calculated in view of the application data and income prediction determined by the computer system. In some examples, the discrepancy module 142 may not verify the income value, but instead may determine if a misrepresentation of an income value is likely to be significant enough to change a determination for approval due to the misrepresentation.

The discrepancy module 142 may scale the comparison between the income value with the income prediction. For example, the income value may be divided by the income prediction and a mathematical calculation may be applied to the resulting number. For example, the computer system may apply a logarithmic function to scale the income value to the determined inflation score. In some examples, an average may be determined, such that four applications may correspond with a zero inflation and one application may correspond with $100,000 inflation, resulting in an average $20,000 inflation score. In other examples, the inflation score may be included in a score range (1 to 1000), where a higher score value may indicate a greater inflation of the income value when compared with a calculated income prediction.

The risk assessment computer system 120 may also comprise one or more machine learning engines, including a first ML engine 144 and a second ML engine 146. The first ML engine 144 may be trained and configured to determine a conservative income prediction associated with the application data by a set of inputs to the first ML model. In some examples, the conservative income prediction determined by the first ML model 144 may be calculated using a quantile regression method or a quantile random forest method. The second ML model 146 may be trained and configured to determine one or more decision likelihood scores based on the set of inputs and one or more other values. For example, the second ML model 144 may determine a first decision likelihood score by applying the income value with the set of inputs to the second ML model and may also determine a second decision likelihood score by applying the conservative income prediction and a set of inputs to the same second ML model.

The first ML engine 144 and second ML engine 146 may be trained. For example, the ML models corresponding with the first ML engine 144 and second ML engine 146 may be trained using historical application data. The historical data may comprise data from a plurality of applications and one or more determinations of application approval or decline. In some examples, the ML models may be trained using a weight applied to one or more input features (e.g., greater weight with a higher correlation of fraud in historical application data, etc.). Signals of fraud may be used to identify risk in subsequent application data prior to the changing the determination for approval. Additional description related to the model training is provided with FIG. 3.

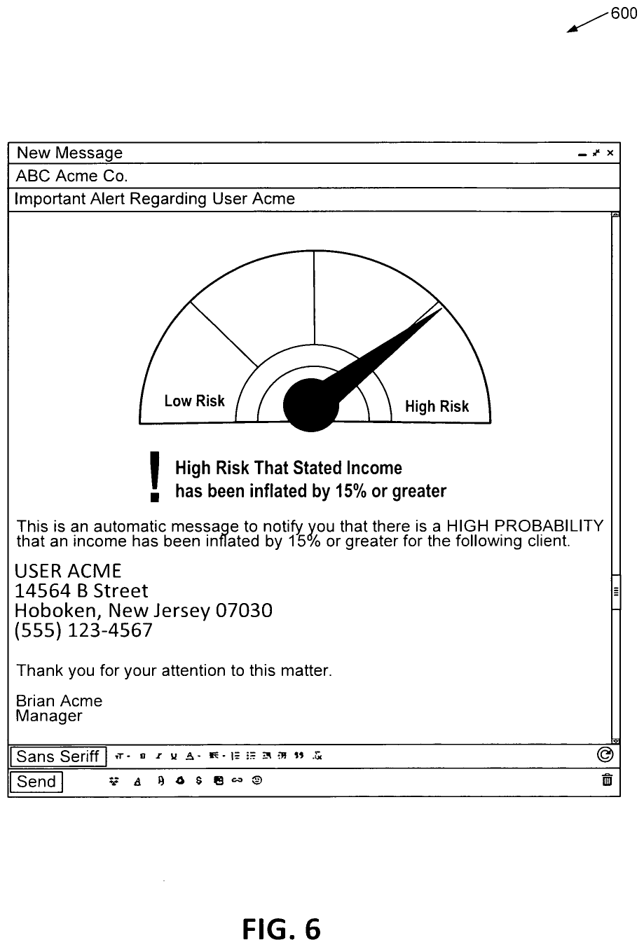

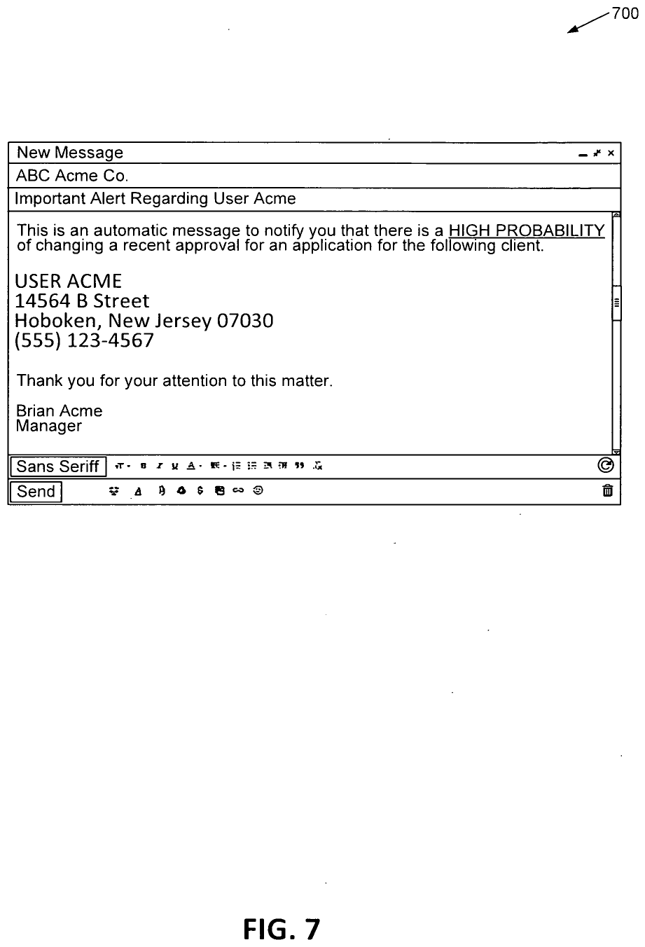

The ML models may provide various output. For example, outputs may include the application identifier, income alert flag (indicating whether the stated income value is likely to be inflated by an amount greater than the acceptable threshold range, e.g., 15 percent), income alert text (describing the alert), one or more reason codes that identify influential reasons for the alert score (e.g., income outside geographic norms, income outside occupation norms, etc.), and/or one or more inputs that are repeated from the application data (e.g., stated income value, employer name, occupation, etc.). One or more of these outputs may be provided with an electronic notification to a user device, as illustrated in FIGS. 6-7.

In some examples, the application data or other user identifiers may be stored with a profile data store 150. In some examples, the user segments and corresponding conservative income predictions associated with the application data and/or one or more user segments may be stored with an income data store 152.

The risk assessment computer system 120 may be configured to provide various outputs, including one or more income prediction scores 160 or one or more decision likelihood score(s) 162. For example, the income prediction scores 160 may be computed by first determining average income for a user segment. In this example, the user segment may correspond with all employees at Acme company for a particular ZIP Code. The risk assessment computer system 120 may determine percentile ranges of income for this user segment including a 10^{th} percentile, 50^{th} percentile, and 90^{th} percentile. Corresponding information for this user segment may be identified as well, including home values, income values, or other pieces of information that may originate from the various application data. Other user segments may be compared as well, including a first user segment corresponding with all programmers at Acme company or a second user segment corresponding with all programmers in a particular ZIP Code. The first ML model may determine an income prediction score 160 based at least in part on the conservative threshold value. For example, the conservative threshold value may be the 15^{th} percentile of income values for the user segment. The income prediction score 160 may correspond with the 15^{th} percentile of income values for all employees at Acme Company for the . particular ZIP Code identified.

One or more decision likelihood scores 162 may also be computed. The decision likelihood scores 162 may be based at least in part on overstating an income value as well as determining whether the overstated income value would have changed the determination for approval. For example, the income value may be overstated to $300,000 and the conservative income prediction may correspond with $85,000, with an actual income of $100,000. The 15^{th} percentile of income values for all employees at Acme company may correspond with the $85,000 income value. In this example, the income value of $100,000 may have been overstated by $200,000 (e.g., $300,000 on the application), but the actual income value of $100,000 may be sufficient to determine approval for the application. As such, the application data may include an overstatement of the income value; however the user corresponding with the overstatement may not be likely to default on a corresponding loan repayment. The likelihood of the application being declined may correlate strongly with its default risk if the application is funded.

The income prediction score 160 or one or more decision likelihood scores 162 may be transmitted to the second user device 112, for example, for the second user to determine the level of diligence required when reviewing the application and/or determination of providing funding to the first user.

In an illustrative example, the risk assessment computer system 120 (via the application engine 136, etc.) may analyze separate data sources and provide the received application data to the one or more ML models to identify if income is reasonable for a particular user. The risk assessment computer system 120 (via the interface engine 132, etc.) may provide the income prediction score 160 or the decision likelihood score 162, or a simplified pass or fail alert based in part on the output of the machine learning models. For example, when the inflation score is within an acceptable threshold range (e.g., 15 percent), then the notification may include a “pass” determination. Otherwise, if the inflation score is greater than 15 percent, the inflation score may include a “fail” determination. In some examples, the notification may include descriptions corresponding with the determination. Illustrative explanations may include that the user's income is very high for stated occupation and employer, the user's income is high based on demographic analysis of similar users, or a user's income exceeds maximum high range for any income source.

The output may be used in various applications and processes. For example, the output may be used to provide one or more electronic messages to the second user device. A first recommendation may correspond with no further action by the second user upon determining that the inflation score is within a first range of values. A second recommendation may correspond with a first action for determining that the inflation score is in a second range of values. A third recommendation may correspond with a second action for determining that the inflation score is in a third range of values. The actions may include, for example, requesting additional application data, requesting additional data from a third-party entity, and the like.

In some examples, the output may correspond with the plurality of adjustable ranges of values associated with a tolerable risk to the second user. For example, the inflation score may be compared with the plurality of adjustable ranges associated with the tolerable risk. One or more recommendations may be provided in association with suggested further actions by the second user. In some examples, none of these actions may correspond with the denial of credit to the first user. The plurality of adjustment ranges of values may be received and adjusted by the second user. In some examples, the plurality of adjustable ranges of values may be based at least in part on daily requirements of the second user (e.g., more risk on day one or less risk on day two, etc.).

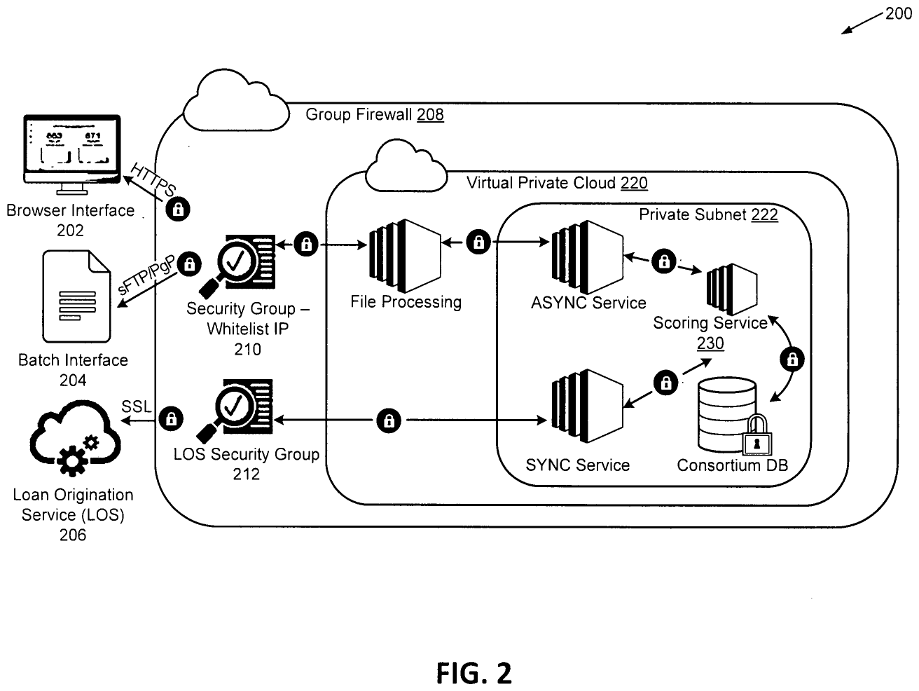

FIG. 2 illustrates a distributed system for risk analysis according to an embodiment of the disclosure. In illustration 200, the risk assessment computer system 120 may receive application data using one or more interfaces. For example, the risk assessment computer system 120 may include a browser interface 202, a batch interface 204, and/or a loan origination service (LOS) 206. The browser interface 202 and the loan origination service 206 may be used to submit application data to the risk assessment computer system 120. The batch interface 204 may he used to submit multiple applications to the risk assessment computer system 120.

In some examples, browser interface 202 may correspond with a website provided for interfacing with a risk assessment computer system 120. The browser interface 202 may allow for a user (e.g., lender, first) to input (e.g., type, drag-and-drop, or provide a file such as XLS, TXT, or CSV) information to the browser interface 202. The information may be submitted in a secure manner, such as using HTTPS and/or SSL. The information may also be encrypted (e.g., PgP encryption).

In some examples, batch interface 204 may allow a user to upload a file (e.g., XLS, TXT, or CSV) to the risk assessment computer system 120. The file may include information associated with one or more loan applications. In some examples, the batch interface 204 may utilize sFTP to send and receive communications. Scheduled batch interface 204 may also encrypt the file (e.g., PgP encryption).

In some examples, loan origination service 206 may be a service (e.g., a web service) that provides a direct connection with the risk assessment computer system 120 (e.g., synchronous). The loan origination service 206 may operate on a first, second, or third user device. The loan origination service 206 may generate an application object for information associated with a loan application, the application object directly used by the risk assessment computer system 120. The loan origination service 206 may then insert information into the application object. The loan origination service 206 may be a service that utilizes HTTP or SSL.

The risk assessment computer system 120 may further include a group firewall 208. The group firewall 208 may include one or more security groups (e.g., security group with whitelist IP list 210 and LOS security group 212). In some examples, the group firewall 208 may be configured to determine whether to allow electronic communications that originate from outside of group firewall 208 to be delivered to a computer system or device inside group firewall 208.

Security group with whitelist IP list 210 may include one or more Internet protocol (IP) addresses that may be allowed to utilize processes described herein. For example, when a device executing a browser interface attempts to send application data associated with the first user, the IP address of the user device may be checked against whitelist IP list 210 to ensure that the user device has permission to utilize services described herein. In one illustrative example, a communication between browser interface and whitelist IP list 210 may be in the form of HTTPS. A similar process may occur when scheduled batch interface sends first user information or application data. In one example, an electronic communication between scheduled batch interface 204 and whitelist IP list 210 may be in the form of sFTP or PgP. Comparatively, the LOS security group 212 may manage security regarding the loan origination service 206 in a similar method as the security group with whitelist IP list 210.

Within the group firewall 208, the risk assessment computer system 120 may include a virtual private cloud 220. The virtual private cloud 220 may host one or more services described herein. For example, the virtual private cloud 220 may host a file processing service. The file processing service may decrypt information received from the browser interface 202 or the batch interface 204, generate an application object (as described above), decrypt information that was previously encrypted for electronic communications, and/or insert the decrypted information into the application object.

Within the group firewall 208, the risk assessment computer system 120 may include a private subnet 222. The private subnet 222 may include ASYNC service, SYNC service, scoring service, consortium database, or any combination thereof. ASYNC service and. SYNC service may facilitate requests to be sent to scoring service 230. In particular, ASYNC service may be used for asynchronous communications, as described with the browser interface 202 and the batch interface 204. SYNC service may be used for synchronous communications, as described with the loan origination service 206.

The scoring service 230 may receive additional information from a consortium. database. The additional information may include information not associated with the application. For example, the additional information may be associated with other applications to be used for comparison. In one illustrative example, consortium database may be a location where historical information related to one or more lenders is stored so it may be analyzed and used by scoring service 230.

The scoring service 230 may determine that a combination of elements may represent a conservative income prediction or a likelihood of changing a determination for approval due to an overstatement of an income value. For example, identity elements associated with an application of a first user may be compared with and not match a third-party data source. The scoring service 230 may determine that the combination of those elements may be represent a potentially inflated income value.

FIG. 3 illustrates a distributed system for training one or more ML models according to an embodiment of the disclosure. In illustration 300, a distributed system is illustrated, including a first user device 310, a second user device 312, and a risk assessment computer system 320. The first user device 310, the second user device 312, and the risk assessment computer system 320 of FIG. 3 may correspond with computers and devices described with FIG. 1, including the second user device 112, third user device 116, and the risk assessment computer system 120, respectively. Components of the risk assessment computer system 320 may be similar to the components of the risk assessment computer system 120, including memory 322, processor(s) 324, communication connection 326, I/O devices 328, and operating system (O/S) 330.

In some examples, devices illustrated herein may comprise a mixture of physical and cloud computing components. Each of these devices may transmit electronic messages via a communication network. Names of these and other computing devices are provided for illustrative purposes and should not limit implementations of the disclosure.

The process of training each ML model may involve providing each ML algorithm with training data to learn from. The training data may originate from the first user device 310, second user device 312, and/or one or more data stores, including the user data store 350 or the income data store 352. Data may comprise application data, income data, and/or optional data, including payment to income (PTI) ratios or debt to income (DTI) ratios.

The data may be split prior to training the models. For example, a first portion of data may be provided as training data and a second portion of data may be provided as test data.

The ML models may be trained by the risk assessment computer system 320 to correspond with a plurality of segments, such that at least one ML model may be trained to determine an output associated with one or more user segments. Various devices or computer systems may assign segmentation information to the application data.

These computing systems may be configured to determine the user segmentation information corresponding with the application data (e.g., via the user module 334). The risk assessment computer system 320 may also be configured to combine user segments. For example, each user segment may correspond with internal job descriptions (e.g., job descriptions that are provided by an individual company or employer) or external jobs descriptions (e.g., job descriptions that are standardized in a particular industry). The internal and external job descriptions may correspond with similar responsibilities and may be standardized to a single user segment. In some examples, similar job descriptions may be combined to a single user segment (e.g., “Manager II” and “Director I” may be combined to “User Segment 123”). In some examples, a combined income value may correspond with a combined user segment. Many factors such as geographic location, company size, and education level factor into the conservative income prediction.

The risk assessment computer system 320 (via the application module 336) may be configured to apply or adjust a weight associated with an input feature based at least in part on historical application data. In some examples, application data associated with applications that occur within a predetermined time range may be weighted higher than application data that occurs outside of the predetermined time range.

When training the first ML model 360, the data provided may determine a conservative income prediction. The data may correlate application data and/or one or more individual user segments (e.g., location, employer, occupation, etc.) with an income value or range of income values. For example, the training data may identify an income value for a plurality of managers as being within a range of $70,000 to $120,000. As another example, the training data may identify an income value for a plurality of managers in Anytown USA as being within a range of $85,000 to $100,000. The income ranges may be provided to the ML model as the target attribute so that the ML model can find patterns in the training data that enable mapping the input data attributes to the conservative income prediction. The trained first ML model may identify these patterns in new data received by the risk assessment computer system.

When training the second ML model 362, the data provided may determine a probability that an overstatement of the income value would result in a change in the approval determination. The data may correlate one or more individual user segments (e.g., location, employer, occupation, etc.) with an income value or range of income values, which in some examples, may be the same input provided to train the first ML model.

The first user device 310 and the second user device 312 may provide data to the risk assessment computer system 320 to initiate the training process. For example, the first user device 310 may receive application data via the application module 311. The second user device 312 may receive income data via the income segment module 313. In some examples, the received data may be aggregated or statistically summarized across different user segments, including statistical summaries associated with location, employer, and occupation; and at different levels of aggregation such as ZIP code, city, and state.

The second user device 112 may be configured to receive data from various data sources. The data sources may include, for example, a third party that aggregates salary data by user segment, a salary assessor, a consortium processor, Internal Revenue Service (IRS) income data, census data (household reported income by ZIP Code), and/or validated incomes from various applications. In some examples, income values may be identified from historical norms and individualized predictions that may be input to the machine learning models, which aggregate to the final assessment of a potentially inflated income risk.

The second user device 312 may receive or determine income values that correspond with different user segments and provide the data to the risk assessment computer system 320 to store in the profile data store 350 or the income data store 352. These data stores may correspond with the profile data store 150 and income data store 152 of FIG. 1, respectively. For example, the second user device 312 may receive income values from current and former employees that review companies and their management. The income values may be provided in an active and intentional data transfer from other user devices. In another example, the second user device 312 may receive an electronic file of a plurality of income values from other user devices that are transmitted directly to the second user device 312 (e.g., via API, email communication, etc.). In yet another example, the second user device 312 may receive income values through passive interactions, including web crawling, cookies, or data scraping third party websites.

As a sample illustration, the second user device 312 may receive an income value of $100,000 associated with a manager from Anytown USA. The second user device 312 may summarize the income value with a plurality of user segments, including a first user segment corresponding with a manager, a second user segment corresponding with any users from Anytown USA, or a combined user segment of managers from Anytown USA. This process may be performed outside of a production system. The received income value may be used to determine an income prediction for each of these user segments. In some examples, the raw data, including the income values and user information corresponding with each income value, may be transmitted to and/or aggregated at the risk assessment computer system 120.

The application engine 336 may be configured to store historical application data and any corresponding risk occurring in association with the application. For example, an application may be submitted and approved by the first user device 310, and the first user device 310 may provide access to an item (e.g., funds) or service (e.g., membership to a restricted club) in response to approving the application. The indication of approval as well as the application data may be stored in the user data store 350. Subsequent interactions with the user may also be identified, including non-repayment of a loan associated with fraudulent information in an application (e.g., inaccurate reporting of a salary of the first user, etc.). The user data store 350 may store input features from the application data that may correlate with an increased likelihood of risk. This updated data may be used to train the first or second ML models.

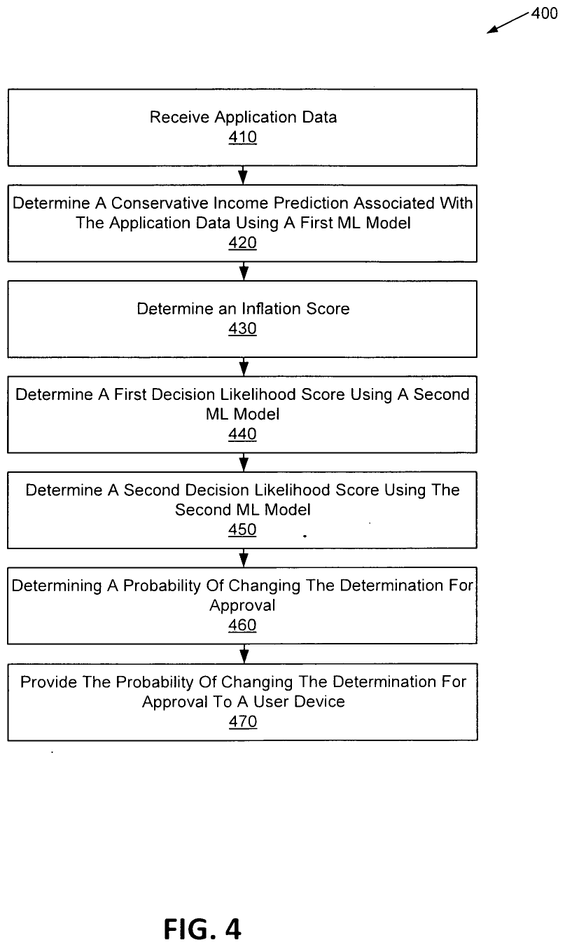

FIG. 4 illustrates a risk. analysis process implemented by a distributed system according to an embodiment of the disclosure. In illustration 400, a risk assessment computer system 120 of FIGS. 1-2 may perform the described process by implementing one or more modules or engines (e.g., including the interface engine 132, the user module 134, the application engine 136, the profiling module 138, the prediction module 140, the discrepancy module 142, the first ML engine 144, and/or the second ML engine 146) to perform these and other actions.

Illustration 400 may be performed under the control of one or more computer systems configured with executable instructions and may be implemented as one or more computer programs or applications executing collectively on one or more processors, by hardware or software. The could they be stored on a computer readable storage medium, for example, in the form of computer program comprising a plurality of instructions executable by one or more processors the computer readable storage media may be non-transitory.

At 410, application data for each user in the user segment may be received. For example, the risk assessment computer system 120 may be configured to receive application data from first user device 110 or second user device 112 (e.g., via the application module 113). The risk assessment computer system 120 may receive the application data corresponding with the first user device 110 associated with a particular user segment. The application data, in some examples, may be provided by the user to request access to an item or service.

The application data may include an income value associated with the user. The income value may be understated, equal to, or overstated, relative to the actual income value of the user.

The application data of the user that request access to the item or service may be dependent on the income value included in application data. For example, the access to the item or service may correspond with a restriction of access to the item or service, including a membership to a building, purchase or loan of the item, and the like. The request for access to the item or service may be approved based at least in part the income value included with the application data.

In some examples, the application data may include user segment information as well. For example, the application may include demographic information of the user. The demographic information may include, for example, and address of the user including a city and state. In some examples, the city and state originating from the application data may be matched to user segment associated with the conservative income prediction to identify a conservative income prediction associated with application data.

The application data may be completed on behalf of a first user for access to an item or service offered by a second user. The second user device may submit the application data in order to request a determination of the risk of permitting access to an item or service. The application data may also correspond with one or more user segments that may be determined by the third user device 116 or. later by the risk assessment computer system 120 (e.g., user segments can include managers, employees from Anytown USA, or managers from Anytown USA, etc.).

The information associated with the first user device 110 may be provided via a web-based form or other network communication protocol. For example, a second user device 112 may select a user selectable option from a webpage and the selection of the option may indicate a submission of the application associated with the first user device 110 by the second user device 112.

At 420, a conservative income prediction may be determined. For example, the risk assessment computer system 120 may be configured to determine a conservative income prediction associated with the application data by applying a set of inputs to a first trained machine-learning (ML) model. The set of inputs may include at least some of the application data. The conservative income prediction may be determined based at least in part on income values and, for example, corresponding job descriptions. The income values used to determine the conservative income prediction may be received from a third user device 116 or a plurality of user applications that have been submitted from first user device 110 or second user device 112.

In some examples, the risk assessment computer system 120 may determine a conservative income prediction by applying a set of inputs to a first trained machine learning (ML) model. At least some of the set of inputs may correspond with the income values transmitted by the third user device 116 or from historical application data. The user segments may correspond with various geographic locations, employment segments, years of experience in a particular industry or career, demographic information, or other user segments or groups. The conservative income prediction may correspond with one or more of these user segments.

In some examples, the distribution of income values may be different based on the second user. For example, the income values and corresponding application data received by the second user may determine, at least in part, the corresponding income predictions or inflation scores of first users that provide application data to the second users.

The risk assessment computer system 120 may compute the conservative income prediction by applying a set of inputs, including the income values corresponding with the internal or external job descriptions, to a first ML model. The first ML model may correspond with linear or non-linear function. For example, the first ML model may comprise a supervised learning algorithm including a decision tree that accepts the one or more input features associated with the application to provide the score.

In some examples, when a nonlinear machine learning model is used, the weightings of fields corresponding with the application data may vary according to one or more user segments corresponding to the application data. This may be illustrated by some occupations corresponding with census data as being the best predictor of an income prediction and other occupations corresponding with Acme company predictions as the best predictor of income predictions. In some examples, government jobs may correspond with a census data source weighted higher than another source for income predictions. In some examples, the weight may be decided through an iterative training process for each ML model.

The first ML model may comprise a neural network that measures the relationship between the dependent variable (e.g., income) and independent variables (e.g., the application data) by using multiple layers of processing elements that ascertain non-linear relationships and interactions between the independent variables and the dependent variable.

The first ML model may further comprise a Deep Learning Neural Network, consisting of more than one layer of processing elements between the input layer and the output later. The first ML model may further be a Convolutional. Neural. Network, in which successive layers of processing elements contain particular hierarchical patterns of connections with the previous layer.

The first ML model may further comprise an. unsupervised learning method, such as k-nearest neighbors, to classify inputs based on observed similarities among the multivariate distribution densities of independent variables in a manner that may correlate with fraudulent activity.

The first ML model may further comprise an ensemble modeling method, which combines scores from a plurality of the above ML methods or other methods to comprise an integrated score.

In some examples, the modeling may include linear regression. The linear regression may model the relationship between the dependent variable (e.g., income) and one or more independent variables (e.g., the application data). In some examples, the dependent variable may be transformed using a logarithm, fixed maximum value, or other transformation or adjustment.

Prior to receiving the input features associated with the application data, the first ML model may be trained using a training data set of historical application data or standardized segment data in a particular industry. For example, the training data set may comprise a plurality of income values for one or more user segments and may determine one or more weights assigned to each of these input features according to an income prediction. When a new job description is received, the first ML model may determine the appropriate user segment to combine with the new job description or may determine to create a new user segment. In some examples, income data across various job descriptions may be combined to form a single user segment.

At 430, an inflation score may be determined. For example, the risk assessment computer system 120 may determine the inflation score by comparing the income value received with the application data to the conservative income prediction determined by the first trained ML model. The inflation score may be associated with an amount that the income is different than the conservative income prediction.

At 440, a first decision likelihood score may be determined using a second ML model. For example, the risk assessment computer system 120 may apply the set of inputs to the second trained ML model. The income value may also be applied with a set of inputs to the second trained ML model. For example, a first score associated with a decision likelihood of being approved may be determined as output of the second trained ML model. In this determination, the set of inputs may be applied to the second trained ML model in addition to the income value received with the application data.

The second trained ML model may correspond with linear or non-linear functions. For example, the second ML model may comprise a supervised learning algorithm including a decision tree that accepts the one or more input features associated with the application to provide the score.

The second ML model may comprise a Naive Bayes classifier that associates independent assumptions between the input features.

The second ML model may comprise logistic regression that measures the relationship between the categorical dependent variable (e.g., the likelihood of application approval) and one or more independent variables (e.g., the application data) by estimating probabilities using a logistic function.

The second ML model may comprise a neural network classifier that measures the relationship between the categorical dependent variable (e.g., the likelihood of application approval) and independent variables (e.g., the application data) by estimating probabilities using multiple layers of processing elements that ascertain non-linear relationships and interactions between the independent variables and the dependent variable.

The second ML model may further comprise a Deep Learning Neural Network, consisting of more than one layer of processing elements between the input layer and the output later. The ML model may further be a Convolutional Neural Network, in which successive layers of processing elements contain particular hierarchical patterns of connections with the previous layer.

The second ML model may further comprise an unsupervised learning method, such as k-nearest neighbors, to classify inputs based on observed similarities among the multivariate distribution densities of independent variables in a manner that may correlate with fraudulent activity.

The second ML model may further comprise an outlier detection method, which identifies significant deviations from the multivariate density distributions of a plurality of independent variables, even if such deviations have not previously been correlated with income misrepresentation in historical application data.

The second ML model may further comprise an ensemble modeling method, which combines scores from a plurality of the above ML methods or other methods to comprise an integrated score.

Prior to receiving the income value and the set of inputs, the second ML model may he trained using a training data set of determinations for approval that correspond with income values. The second ML model may be trained using historical data to determine one or more weights assigned to each of the input features. In some examples, input features from the historical data that are common amongst a subset of applications may be identified as indicators of higher probabilities of approval.

At 450, a second decision likelihood score may be determined using the second ML model. For example, the risk assessment computer system 120 may determine the second decision likelihood score using a similar process as the first decision likelihood score. For the second decision likelihood score, the second ML model may receive the set of inputs to the second trained ML model as well as the conservative income prediction to be applied with a set of inputs to the second trained ML model.

At 460, a probability of changing the determination for approval may be estimated. For example, the risk assessment computer system 120 may determine a score corresponding to an estimate of the probability of changing the determination for approval associated with the application data due to a determined (e.g., calculated, estimated, predicted, etc.) overstatement of the income value. In some examples, the risk assessment computer system 120 may compare the first decision likelihood score with the second decision likelihood score to determine the probability of changing the determination for approval associated with the application data due to a determined overstatement of the income value.

At 470, the probability of changing the determination for approval may be provided to a user device. For example, the risk assessment computer system 120 may transmit the probability of changing the determination for approval associated with the application data due to a determined overstatement of the income value or a related electronic message to a user device. In some examples, the probability may be provided as a score (e.g., textual or numeral, including, for example, within a range of 0 to 1000, “low” or “high” probability, etc.). The electronic message may also identify at least one output from the ML models and processes described herein.

As a sample illustration, a high probability of changing the determination for approval due to the overstatement of the income value may correspond with a score of 700 or greater. Accordingly, any income value associated with an application with a score above a threshold of 700, for example, may correspond with a high likelihood that a second user would change a determination from approval to decline based at least in part on fraudulent information included in the application related to the income value. In another example, a medium probability of changing the determination for approval due to the overstatement of the income value may correspond with a score in a range of 300 to 700. Accordingly, any application with the score in the medium threshold range may be determined to be a medium risk or correspond with a medium likelihood that a second user would change a determination from approval to decline based on the misrepresented income value. In another example, a low probability of changing the determination for approval due. to the overstatement of income may correspond with a score in a range of one to 299. Accordingly, any application with a score between one and 299 may be determined to be low risk, or, in some examples, would correspond with a low probability of changing the determination for approval due to overstatement of the income value in the original application data.

In some examples, the probability of changing the determination for approval may accompany additional data. For example, a reason code may be determined based on the input features that appear to be most prominent in the income prediction or decision likelihood scores. In another example, one or more actions may be determined and provided based. on the input features that appear to be most prominent in the income prediction or decision likelihood scores. Reason codes or suggested actions may be included, in some examples, with electronic notifications to the user device(s).

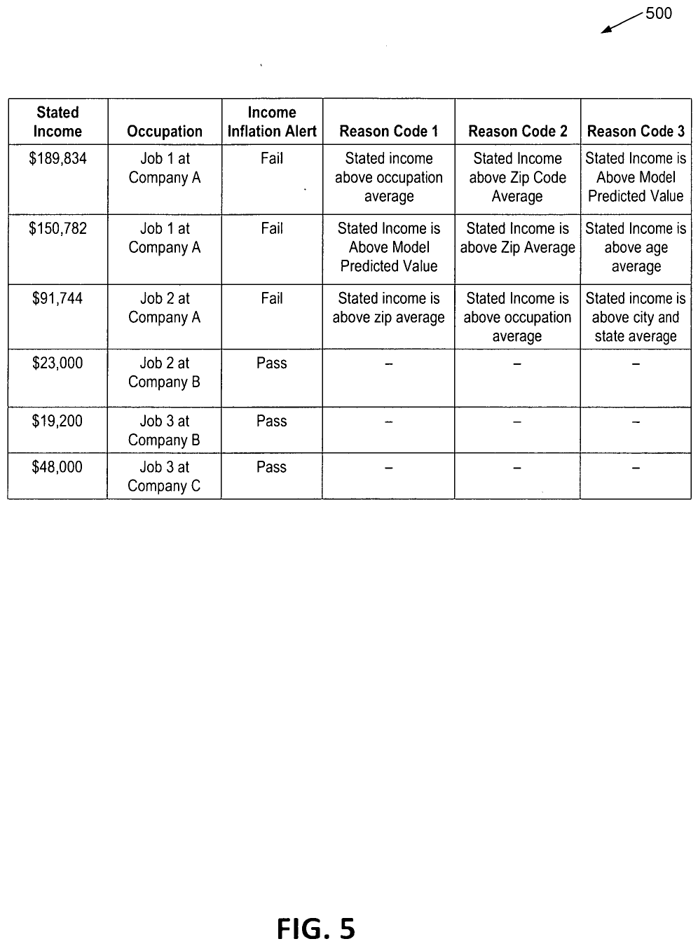

FIG. 5 illustrates a sample output according to an embodiment of the disclosure. In illustration 500, the output may include information originating from the original application data, including stated income values or occupation, as well as determined information from the one or more ML models.

At row one of FIG. 5, for example, User A may provide an income value of $189,834 corresponding with their occupation at Company A doing Job 1. When the income value and application data are provided with the set of inputs to the first ML model, the computer system may determine that the inflation score is greater than an acceptable threshold range for overstatements of income values. The computer system may also provide one or more reason codes corresponding with the failure, including the stated income is above an occupation average, the stated income is above a ZIP Code average, or the stated income is above a model predicted value (e.g., the conservative income prediction, etc.).

At row two, User B may provide an income value of $150,782 corresponding with their occupation at Company A doing Job 1. In this example, User A and User B have provided. different income values corresponding with the same occupation and company. However, as illustrated, both income values may correspond with overstatements when compared to the conservative income prediction for the job at that particular company.

At row three, User C may provide an income value of $91,744 corresponding with their occupation at Company A doing Job 2. In this example, Users A, B, and C have provided different income values corresponding with the same company, yet stating different occupations. However, as illustrated, the income value corresponding with the particular job at Company A may correspond with an overstatement when compared to the conservative income prediction for the particular job at that particular company.

At rows four through six, these users may provide income values, jobs, and companies that correspond with the income prediction for these particular user segments. When comparing each of the income values with the income predictions, the computer system may determine inflation scores that are within the acceptable threshold range. In some examples, the computer system may not recommend additional actions associated with these applications. These suggestions for no further action may, at least in part, increase efficiency and streamline electronic processing of approval or disapproval of these applications.

FIG. 6 illustrates a notification according to an embodiment of the disclosure. In illustration 600, an example electronic communication may include information associated with a user that may have overstated an income value. Additional information may include a first decision likelihood score or a second decision likelihood score, suggested actions, or graphical. representations of the scores. The notification may be transmitted as an electronic communication via a communication protocol to a user device.

FIG. 7 illustrates a notification according to an embodiment of the disclosure. In illustration 700, an example electronic communication may include information associated with a calculated likelihood of changing a determination for approval due to an overstatement of an income value. Additional information may include a first decision likelihood score or a second decision likelihood score, suggested actions, or graphical representations of the scores. The notification may be transmitted as an electronic communication via a communication protocol to a user device.

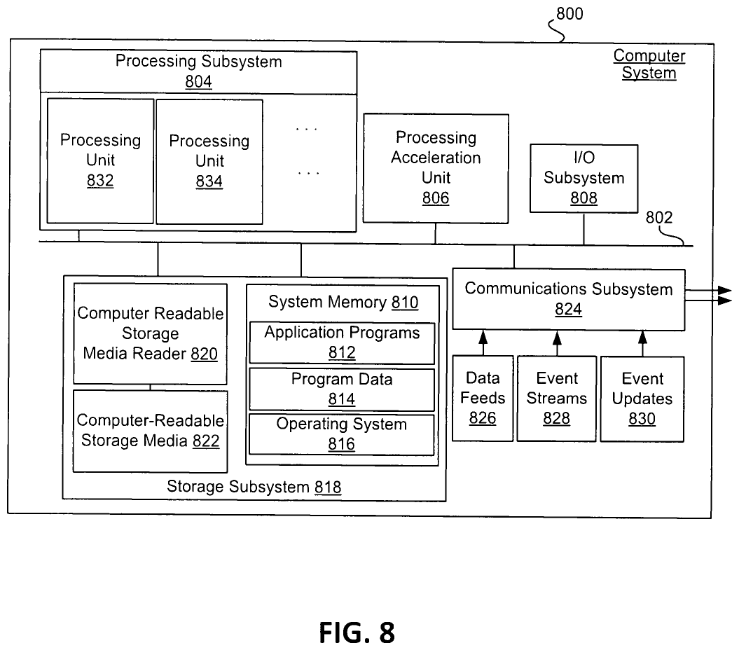

FIG. 8 illustrates an example of a computer system that may be used to implement certain embodiments of the disclosure. For example, in some embodiments, computer system 800 may be used to implement any of the systems, servers, devices, or the like described above. As shown in FIG. 8, computer system 800 includes processing subsystem 804, which communicates with a number of other subsystems via bus subsystem 802. These other subsystems may include processing acceleration unit 806, I/O subsystem 808, storage subsystem 818, and communications subsystem 824. Storage subsystem 818 may include non-transitory computer-readable storage media including storage media 822 and system memory 810.

Bus subsystem 802 provides a mechanism for allowing the various components and subsystems of computer system 800 to communicate with each other. Although bus subsystem 802 is shown schematically as a single bus, alternative embodiments of bus subsystem 802 may utilize multiple buses. Bus subsystem 802 may be any of several types of bus structures including a memory bus or memory controller, a peripheral bus, a local bus using any of a variety of bus architectures, and the like. For example, such architectures may include an industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which may be implemented as a Mezzanine bus manufactured to the IEEE P1386.1 standard, and the like.

Processing subsystem 804 controls the operation of computer system 800 and may comprise one or more processors, application specific integrated circuits (ASICs), or field programmable gate arrays (FPGAs). The processors may include single core and/or multicore processors. The processing resources of computer system 800 may be organized into one or more processing units 832, 834, etc. A processing unit may include one or more processors, one or more cores from the same or different processors, a combination of cores and processors, or other combinations of cores and processors. In some embodiments, processing subsystem 804 may include one or more special purpose co-processors such as graphics processors, digital signal processors (DSPs), or the like. In some embodiments, some or all of the processing units of processing subsystem 804 may be implemented using customized circuits, such as application specific integrated circuits (ASICs), or field programmable gate arrays (FPGAs).

In some embodiments, the processing units in processing subsystem 804 may execute instructions stored in system memory 810 or on computer readable storage media 822. In various embodiments, the processing units may execute a variety of programs or code instructions and may maintain multiple concurrently executing programs or processes. At any given time, some or all of the program code to be executed may be resident in system memory 810 and/or on computer-readable storage media 822 including potentially on one or more storage devices. Through suitable programming, processing subsystem 804 may provide various functionalities described above. In instances where computer system 800 is executing one or more virtual machines, one or more processing units may be allocated to each virtual machine.

In certain embodiments, processing acceleration unit 806 may optionally be provided for performing customized processing or for off-loading some of the processing performed by processing subsystem 804 so as to accelerate the overall processing performed by computer system 800.

I/O subsystem 808 may include devices and mechanisms for inputting information to computer system 800 and/or for outputting information from or via computer system 800. In general, use of the term input device is intended to include all possible types of devices and mechanisms for inputting information to computer system 800. User interface input devices may include, for example, a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may also include motion sensing and/or gesture recognition devices that enable users to control and interact with an input device and/or devices that provide an interface for receiving input using gestures and spoken commands. User interface input devices may also include eye gesture recognition devices that detects eye activity (e.g., “blinking” while taking pictures and/or making a menu selection) from users and transforms the eye gestures as inputs to an input device. Additionally, user interface input devices may include voice recognition sensing devices that enable users to interact with voice recognition systems through voice commands.

Other examples of user interface input devices include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, barcode reader 3D scanners, 3D printers, laser rangefinders, and eye gaze tracking devices. Additionally, user interface input devices may include, for example, medical imaging input devices such as computed tomography, magnetic resonance imaging, position emission tomography, and medical ultrasonography devices. User interface input devices may also include, for example, audio input devices such as MIDI keyboards, digital musical instruments and the like.

In general, use of the term output device is intended to include all possible types of devices and mechanisms for outputting information from computer system 800 to a user or other computer system. User interface output devices may include a display subsystem, indicator lights, or non-visual displays such as audio output devices, etc. The display subsystem may be a cathode ray tube (CRT), a flat-panel. device, such as that using a liquid crystal display (LCD) or plasma display, a projection device, a touch screen, and the like. For example, user interface output devices may include, without limitation, a variety of display devices that visually convey text, graphics and audio/video information such as monitors, printers, speakers, headphones, automotive navigation systems, plotters, voice output devices, and moderns.

Storage subsystem 818 provides a repository or data store for storing information and data that is used by computer system 800. Storage subsystem 818 provides a tangible non-transitory computer-readable storage medium for storing the basic programming and data constructs that provide the functionality of some embodiments. Storage subsystem 818 may store software (e.g., programs, code modules, instructions) that, when executed by processing subsystem 804, provides the functionality described above. The software may be executed by one or more processing units of processing subsystem 804. Storage subsystem 818 may also provide a repository for storing data used in accordance with the teachings of this disclosure.

Storage subsystem 818 may include one or more non-transitory memory devices, including volatile and non-volatile memory devices. As shown in FIG. 8, storage subsystem 818 includes system memory 810 and computer-readable storage media 822. System memory 810 may include a number of memories, including (1) a volatile main random access memory (RAM) for storage of instructions and data during program execution and (2) a non-volatile read only memory (ROM) or flash memory in which fixed instructions are stored. In some implementations, a basic input/output system (BIOS), including the basic routines that help to transfer information between elements within computer system 800, such as during start-up, may typically he stored in the ROM. The RAM typically includes data and/or program modules that are presently being operated and executed by processing subsystem 804. In some implementations, system memory 810 may include multiple different types of memory, such as static random access memory (SRAM), dynamic random access memory (DRAM), and the like.

By way of example, and not limitation, as depicted in FIG. 8, system memory 810 may load application programs 812 that are being executed, which may include various applications such as Web browsers, mid-tier applications, relational database management systems (RDBMS), etc., program data 814, and operating system 816.

Computer-readable storage media 822 may store programming and data constructs that provide the functionality of some embodiments. Computer-readable media 822 may provide storage of computer-readable instructions, data structures, program modules, and other data for computer system 800. Software (programs, code modules, instructions) that, when executed by processing subsystem 804 provides the functionality described above, may be stored in storage subsystem 818. By way of example, computer-readable storage media 822 may include non-volatile memory such as a hard disk drive, a magnetic disk drive, an optical disk drive such as a CD ROM, DVD, a Blu-Ray® disk, or other optical media. Computer-readable storage media 822 may include, but is not limited to, Zip® drives, flash memory cards, universal serial bus (USB) flash drives, secure digital (SD) cards, DVD disks, digital video tape, and the like. Computer-readable storage media 822 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, DRAM-based SSDs, magnetoresistive RAM (MRAM) SSDs, and hybrid SSDs that use a combination of DRAM and flash memory based SSDs.

In certain embodiments, storage subsystem 818 may also include computer-readable storage media reader 820 that may further be connected to computer-readable storage media 822. Reader 820 may receive and be configured to read data from a memory device such as a disk, a flash drive, etc.

In certain embodiments, computer system 800 may support virtualization technologies, including but not limited to virtualization of processing and memory resources. For example, computer system 800 may provide support for executing one or more virtual machines. In certain embodiments, computer system 800 may execute a program such as a hypervisor that facilitated the configuring and managing of the virtual machines. Each virtual machine may be allocated memory, compute (e.g., processors, cores), 110, and networking resources. Each virtual machine generally runs independently of the other virtual machines. A virtual machine typically runs its own operating system, which may be the same as or different from the operating systems executed by other virtual machines executed by computer system 800. Accordingly, multiple operating systems may potentially be run concurrently by computer system 800.

Communications subsystem 824 provides an interface to other computer systems and networks. Communications subsystem 824 serves as an interface for receiving data from and transmitting data to other systems from computer system 800. For example, communications subsystem 824 may enable computer system 800 to establish a communication channel to one or more client devices via the Internet for receiving and sending information from and to the client devices.

Communication subsystem 824 may support both wired and/or wireless communication protocols. For example, in certain embodiments, communications subsystem 824 may include radio frequency (RF) transceiver components for accessing wireless voice and/or data networks (e.g., using cellular telephone technology, advanced data network technology, such as 3G, 4G or EDGE (enhanced data rates for global evolution), WiFi (IEEE 802.XX family standards, or other mobile communication technologies, or any combination thereof), global positioning system (GPS) receiver components, and/or other components. In some embodiments, communications subsystem 824 may provide wired network connectivity (e.g., Ethernet) in addition to or instead of a wireless interface.

Communication subsystem 824 may receive and transmit data in various forms. For example, in some embodiments, in addition to other forms, communications subsystem 824 may receive input communications in the form of structured and/or unstructured data feeds 826, event streams 828, event updates 830, and the like. For example, communications subsystem 824 may be configured to receive (or send) data feeds 826 in real-time from users of social media networks and/or other communication services such as web feeds and/or real-time updates from one or more third party information sources.

In certain embodiments, communications subsystem 824 may be configured to receive data in the form of continuous data streams, which may include event streams 828 of real-time events and/or event updates 830, that may he continuous or unbounded in nature with no explicit end. Examples of applications that generate continuous data may include, for example, sensor data applications, financial tickers, network performance measuring tools (e.g. network monitoring and traffic management applications), clickstream analysis tools, automobile traffic monitoring, and the like.

Communications subsystem 824 may also be configured to communicate data from computer system 800 to other computer systems or networks. The data may be communicated in various different forms such as structured and/or unstructured data feeds 826, event streams 828, event updates 830, and the like to one or more databases that may be in communication with one or more streaming data source computers coupled to computer system 800.

Computer system 800 may be one of various types, including a handheld portable device, a wearable device, a personal computer, a workstation, a mainframe, a kiosk, a server rack, or any other data processing system. Due to the ever-changing nature of computers and networks, the description of computer system 800 depicted in FIG. 8 is intended only as a specific example. Many other configurations having more or fewer components than the system depicted in FIG. 8 are possible. Based on the disclosure and teachings provided herein, a person of ordinary skill in the art will appreciate other ways and/or methods to implement the various embodiments.

In the preceding description, for the purposes of explanation, specific details are set forth in order to provide a thorough understanding of examples of the disclosure. However, it should be apparent that various examples may be practiced without these specific details. For example, circuits, systems, networks, processes, and other components may be shown as components in block diagram form in order to not obscure the examples in unnecessary detail. In other instances, well-known circuits, processes, algorithms, structures, and techniques may have been shown without necessary detail in order to avoid obscuring the examples. The figures and description are not intended to be restrictive.

The description provides examples only. and is not intended to limit the scope, applicability, or configuration of the disclosure. Rather, the description of the examples provides those skilled in the art with an enabling description for implementing an example. It should be understood that various changes may be made in the function and arrangement of elements without departing from the spirit and scope of the disclosure as set forth in the appended claims.

Also, it is noted that individual examples may be described as a process which is depicted as a flowchart, a flow diagram, a data flow diagram, a structure diagram, or a block diagram. Although a flowchart may describe the operations as a sequential process, many of the operations may be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination may correspond to a return of the function to the calling function or the main function.

The term “machine-readable storage medium” or “computer-readable storage medium” includes, but is not limited to, portable or non-portable storage devices, optical storage devices, and various other mediums capable of storing, including, or carrying instruction(s) and/or data. A machine-readable storage medium or computer-readable storage medium may include a non-transitory medium in which data may be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (.DVD), flash memory, memory or memory devices. A computer-program product may include code and/or machine-executable instructions that may represent a procedure, a function, a subprogram, a program, a routine, a subroutine, a module, a software package, a class, or any combination of instructions, data structures, or program statements.

Furthermore, examples may be implemented by hardware, software, firmware, middleware, microcode, hardware description languages, or any combination thereof. When implemented in software, firmware, middleware or microcode, the program code or code segments to perform the necessary tasks (e.g., a computer-program product) may be stored in a machine-readable medium. One or more processors may execute the software, firmware, middleware, microcode, the program code, or code segments to perform the necessary tasks.

Systems depicted in some of the figures may be provided in various configurations. In some embodiments, the systems may be configured as a distributed system where one or more components of the system are distributed across one or more networks such as in a cloud computing system.

Where components are described as being “configured to” perform certain operations, such configuration may be accomplished, for example, by designing electronic circuits or other hardware to perform the operation, by programming programmable electronic circuits (e.g., microprocessors, or other suitable electronic circuits) to perform the operation, or any combination thereof.

The terms and expressions that have been employed in this disclosure are used as terms of description and not of limitation, and there is no intention in the use of such terms and expressions of excluding any equivalents of the features shown and described or portions thereof. It is recognized, however, that various modifications are possible within the scope of the systems and methods claimed. Thus, it should be understood that, although certain concepts and techniques have been specifically disclosed, modification and variation of these concepts and techniques may be resorted to by those skilled in the art, and that such modifications and variations are considered to be within the scope of the systems and methods as defined by this disclosure.

Although specific embodiments have been described, various modifications, alterations, alternative constructions, and equivalents are possible. Embodiments are not restricted to operation within certain specific data processing environments, but are free to operate within a plurality of data processing environments. Additionally, although certain embodiments have been described using a particular series of transactions and steps, it should be apparent to those skilled in the art that this is not intended to be limiting. Although some flowcharts describe operations as a sequential process, many of the operations may be performed in parallel or concurrently. In addition, the order of the operations may be rearranged. A process may have additional steps not included in the figure. Various features and aspects of the above-described embodiments may be used individually or jointly.

Further, while certain embodiments have been described using a particular combination of hardware and software, it should be recognized that other combinations of hardware and software are also possible. Certain embodiments may be implemented only in hardware, or only in software, or using combinations thereof. In one example, software may be implemented as a computer program product including computer program code or instructions executable by one or more processors for performing any or all of the steps, operations, or processes described in this disclosure, where the computer program may be stored on a non-transitory computer readable medium. The various processes described herein may be implemented on the same processor or different processors in any combination.

Where devices, systems, components or modules are described as being configured to perform certain operations or functions, such configuration may be accomplished, for example, by designing electronic circuits to perform the operation, by programming programmable electronic circuits (such as microprocessors) to perform the operation such as by executing computer instructions or code, or processors or cores programmed to execute code or instructions stored on a non-transitory memory medium, or any combination thereof. Processes may communicate using a variety of techniques including but not limited to conventional techniques for inter-process communications, and different pairs of processes may use different techniques, or the same pair of processes may use different techniques at different times.

Specific details are given in this disclosure to provide a thorough understanding of the embodiments. However, embodiments may be practiced without these specific details. For example, well-known circuits, processes, algorithms, structures, and techniques have been shown without unnecessary detail in order to avoid obscuring the embodiments. This description provides example embodiments only, and is not intended to limit the scope, applicability, or configuration of other embodiments. Rather, the preceding description of the embodiments will provide those skilled in the art with an enabling description for implementing various embodiments. Various changes may be made in the function and arrangement of elements.

The specification and drawings are, accordingly, to be regarded in an illustrative rather than a restrictive sense. It will, however, be evident that additions, subtractions, deletions, and other modifications and changes may be made thereunto without departing from the broader spirit and scope as set forth in the claims. Thus, although specific embodiments have been described, these are not intended to be limiting. Various modifications and equivalents are within the scope of the following claims.

What is claimed is:

1. A method for determining a probability of changing a determination for approval due to an overstatement of an income value, the method comprising:
receiving, by the computer system, application data by a user requesting access to an item or service, wherein the application data includes the income value, and wherein the application data corresponds with a user segment;
determining, by a computer system, a conservative income prediction associated. with the application data by applying a set of inputs to a first trained machine-learning (ML) model, wherein the set of inputs includes at least some of the application data;
determining an inflation score by comparing the income value with the conservative income prediction, wherein the inflation score is associated with an amount the income value is different than the conservative income prediction;
determining, by the computer system, a first decision likelihood score by applying the income value and the set of inputs to a second trained ML model;
determining, by the computer system, a second decision likelihood score by applying the conservative income prediction and the set of inputs to the second trained ML model; and
determining the probability of changing the determination for approval due to the overstatement of the income value by comparing the first decision likelihood score with the second decision likelihood score; and
providing, by the computer system, the probability of changing the determination for approval to a user device.

2. The method of claim 1, wherein the comparison of the first decision likelihood score with the second decision tolerance score includes subtracting the second decision likelihood score from the first decision likelihood score.

3. The method of claim 2, wherein the conservative income prediction is calculated using a quantile regression method or quantile random forest method.

4. The method of claim 2, wherein the application data does not include personally identifiable information (PII) of the user.

5. A non-transitory computer-readable storage medium storing a plurality of instructions executable by one or more processors, the plurality of instructions when executed by the one or more processors cause the one or more processors to:
receive application data by a user requesting access to an item or service, wherein the application data includes the income value, and wherein the application data corresponds with a user segment;
determine a conservative income prediction associated with the application data by applying a set of inputs to a first trained machine-learning (ML) model, wherein the set of inputs includes at least some of the application data;
determine an inflation score by comparing the income value with the conservative income prediction, wherein the inflation score is associated with an amount the income value is different than the conservative income prediction;
determine a first decision likelihood score by applying the income value and the set of inputs to a second trained ML model;
determine a second decision likelihood score by applying the conservative income prediction and the set of inputs to the second trained ML model;
determine the probability of changing the determination for approval due to the overstatement of the income value by comparing the first decision likelihood score with the second decision likelihood score; and
provide the probability of changing the determination for approval to a user device.

6. The non-transitory computer-readable storage medium of claim 5, wherein the comparison of the first decision likelihood score with the second decision tolerance score includes subtracting the second decision likelihood score from the first decision likelihood score.

7. The non-transitory computer-readable storage medium of claim 5, wherein the conservative income prediction is calculated using a quantile regression method or quantile random forest method.

8. The non-transitory computer-readable storage medium of claim 5, wherein the application data does not include personally identifiable information (PII) of the user.

9. A system comprising:
one or more processors; and
a non-transitory computer-readable medium including instructions that, when executed by the one or more processors, cause the one or more processors to:
receive application data by a user requesting access to an item or service, wherein the application data includes the income value, and wherein the application data corresponds with a user segment;
determine a conservative income prediction associated with the application data by applying a set of inputs to a first trained machine-learning (ML) model, wherein the set of inputs includes at least some of the application data;
determine an inflation score by comparing the income value with the conservative income prediction, wherein the inflation score is associated with an amount the income value is different than the conservative income prediction;
determine a first decision likelihood score by applying the income value and the set of inputs to a second trained ML model;
determine a second decision likelihood score by applying the conservative income prediction and the set of inputs to the second trained ML model;
determine the probability of changing the determination for approval due to the overstatement of the income value by comparing the first decision likelihood score with the second decision likelihood score; and
provide the probability of changing the determination for approval to a user device.

10. The system of claim 9, wherein the comparison of the first decision likelihood score with the second decision tolerance score includes subtracting the second decision likelihood score from the first decision likelihood score.

11. The system of claim 9, wherein the conservative income prediction is calculated using a quantile regression method or quantile random forest method.

12. The system of claim 9, wherein the application data does not include personally identifiable information (PII) of the user.
